(19) United States
(12) Patent Application Publication
(10) Pub. No.: US 2025/0084768 A1
(43) Pub. Date: Mar. 13, 2025

(54) ANNULUS FILLER FOR A GAS TURBINE ENGINE

(71) Applicant: ROLLS-ROYCE plc, London (GB)

(72) Inventors: Andrew MEKERESZ, Derby (GB); Anastasios KOVANIS, Derby (GB); John J. BOLGER, Derby (GB); Benedict R PHELPS, Derby (GB)

(73) Assignee: ROLLS-ROYCE plc, London (GB)

(21) Appl. No.: 18/808,248

(22) Filed: Aug. 19, 2024

(30) Foreign Application Priority Data
Sep. 8, 2023 (GR) 20230100723

(51) Int. Cl. F01D 11/00

(52) U.S. Cl. CPC F01D 11/008; F05D 2260/30

(57) ABSTRACT

An annulus filler of a gas turbine engine includes an outer lid including a leading edge, a trailing edge, a first longitudinal edge, a second longitudinal edge, and an outer radial surface. The outer radial surface includes a first nominal surface portion and a second nominal surface portion. The outer radial surface further includes a protruding surface portion extending radially outwardly from each of the first nominal surface portion and the second nominal surface portion and a recessed surface portion extending radially inwardly from each of the first nominal surface portion and the second nominal surface portion. Each of the protruding surface portion and the recessed surface portion is configured to redirect an air drawn through the gas turbine engine.

### CROSS-REFERENCE TO RELATED APPLICATIONS

This specification is based upon and claims the benefit of priority from Greek patent application number GR 20230100723 filed on Sep. 8, 2023, the entire contents of which is incorporated herein by reference.

### BACKGROUND

### Technical Field

The present disclosure generally relates to an annulus filler for a gas turbine engine.

### Description of the Related Art

A rotor stage in a gas turbine engine generally includes a plurality of radially extending rotor blades mounted on a rotor disc. Passages between adjacent rotor blades near a radially inward portion of the rotor blades adjacent to the rotor disc may be filled by platforms integral to the respective rotor blades or by annulus fillers, which are separate from the rotor blades. In the latter case, annulus fillers may define a radially inward airflow surface for air being drawn through the gas turbine engine as the air passes over the rotor disc.

Annulus fillers typically include engagement features for removably attaching the annulus filler to the rotor disc, and an annulus filler lid defining the radially inward airflow surface. Generally, a shape of the annulus filler lid is produced by revolving a desired profile around an engine axis. This results in a uniform radial surface for the annulus filler lid. The uniform radial surface may be unable to influence the air passing over the annulus filler in order to achieve desirable outcomes.

### SUMMARY

According to a first aspect, there is provided an annulus filler for mounting to a rotor disc of a gas turbine engine. The annulus filler includes a coupling portion connectable to the rotor disc. The annulus filler further includes an outer lid coupled to the coupling portion and extending axially, radially, and circumferentially with respect to a central axis. The outer lid is configured to be at least partially and circumferentially disposed between two adjacent blades connected to the rotor disc. The outer lid includes a leading edge that extends at least circumferentially with respect to the central axis. The outer lid further includes a trailing edge that is axially spaced apart from the leading edge and extending at least circumferentially with respect to the central axis. The outer lid further includes a first longitudinal edge extending at least axially between the leading edge and the trailing edge with respect to the central axis. The outer lid further includes a second longitudinal edge circumferentially spaced apart from the first longitudinal edge with respect to the central axis. The second longitudinal edge extends at least axially between the leading edge and the trailing edge with respect to the central axis. The outer lid further includes an outer radial surface configured to contact an air drawn through the gas turbine engine. The outer radial surface is delimited by the leading edge, the trailing edge, the first longitudinal edge, and the second longitudinal edge. The outer radial surface includes a first nominal surface portion extending axially from the leading edge towards the trailing edge and extending circumferentially between the first longitudinal edge and the second longitudinal edge. The first nominal surface portion is formed as a first part of a surface of revolution about the central axis. The outer radial surface further includes a second nominal surface portion axially spaced apart from the first nominal surface portion. The second nominal surface portion extends axially from the trailing edge towards the leading edge and extends circumferentially between the first longitudinal edge and the second longitudinal edge. The second nominal surface portion is formed as a second part of the surface of revolution about the central axis. The outer radial surface further includes a protruding surface portion extending circumferentially from the first longitudinal edge and axially disposed between the first nominal surface portion and the second nominal surface portion. The protruding surface portion is contiguous with each of the first nominal surface portion and the second nominal surface portion. The outer radial surface further includes a recessed surface portion extending circumferentially from the second longitudinal edge and axially disposed between the first nominal surface portion and the second nominal surface portion. The recessed surface portion is disposed adjacent to the protruding surface portion and is contiguous with each of the first nominal surface portion and the second nominal surface portion. Each of the protruding surface portion and the recessed surface portion is configured to redirect the air drawn through the gas turbine engine.

The outer radial surface of the outer lid of the annulus filler of the present disclosure includes the protruding surface portion extending radially outwardly from each of the first nominal surface portion and the second nominal surface portion with respect to the central axis and the recessed surface portion extending radially inwardly from one or each of the first nominal surface portion and the second nominal surface portion with respect to the central axis. Further, the recessed surface portion is disposed adjacent to the protruding surface portion. The protruding surface portion and the recessed surface portion of the outer radial surface may allow a non-axisymmetric profile for a radially outer surface of the rotor disc, thereby influencing the air drawn through the gas turbine engine as the air passes over the outer radial surface of the outer lid. Specifically, the protruding surface portion and the recessed surface portion may provide a circumferentially variable surface to the outer lid, thereby influencing the air flowing through a passage between the adjacent blades (i.e., a passage flow) as the air passes over the outer lid of the annulus filler.

The shape of the outer lid of the annulus filler may result in a variation of cross-passage pressure gradients and an aerodynamic loading of the adjacent blades. Specifically, the shape of the outer lid may influence a topology of a secondary flow (generated by cross-passage pressure gradients) at a blade hub of the blades. More specifically, the aforementioned aerodynamic behaviour may influence an axial location where a vortical structure of the secondary flow is formulated, a radial position of the vortical structure, and an intensity of the vortical structure, thereby mitigating dissipative losses caused by the secondary flows generated between the adjacent blades.

The secondary flow may travel downstream to subsequent rotor stages. The annulus filler of the present disclosure may not only increase an efficiency of a blade root component of the blades at the blade hub but also enables reduction in induced forced vibrations of the subsequent rotor stages. Thus, the annulus filler may improve an efficiency of the gas turbine engine. The aforementioned desirable effects work at all operating conditions of the gas turbine engine and are most effective during cruise conditions, which is a major part of engine operational cycle.

In some embodiments, the protruding surface portion further extends radially outwardly from each of the first nominal surface portion and the second nominal surface portion with respect to the central axis, and the recessed surface portion further extends radially inwardly from one or each of the first nominal surface portion and the second nominal surface portion with respect to the central axis.

In some embodiments, the outer radial surface defines a nominal plane extending between the leading edge and the trailing edge and forming a part of the surface of revolution about the central axis, the protruding surface portion further extends radially outwardly from each of the first nominal surface portion and the second nominal surface portion with respect to the nominal plane, and the recessed surface portion further extends radially inwardly from one or each of the first nominal surface portion and the second nominal surface portion with respect to the nominal plane.

In some embodiments, the outer radial surface extends at least axially with respect to the central axis by a maximum axial length. Each of the protruding surface portion and the recessed surface portion extends at least axially with respect to the central axis by a maximum axial extent. The maximum axial extent of each of the protruding surface portion and the recessed surface portion is at most 45% of the maximum axial length of the outer radial surface. Each of the protruding surface portion and the recessed surface portion may extend at least axially to enable optimal manipulation of the secondary flow at the blade hub of the adjacent blades.

In some embodiments, an axial distance between the leading edge of the outer lid and a proximal end of the protruding surface portion or a proximal end of the recessed surface portion with respect to the central axis is from 30% to 75% of the maximum axial length of the outer radial surface. This may allow manipulation of the secondary flow to generate the aforementioned aerodynamic effects.

In some embodiments, the protruding surface portion includes a protruding peak that is radially outermost with respect to the central axis. The recessed surface portion includes a recessed peak that is radially innermost with respect to the central axis. An axial distance between the leading edge of the outer lid and each of the protruding peak and the recessed peak with respect to the central axis is from 30% to 75% of the maximum axial length of the outer radial surface. The axial distance between the leading edge of the outer lid and each of the protruding peak and the recessed peak with respect to the central axis may provide optimal manipulation of the secondary flow.

Additionally, the recessed surface portion may enable a reduction in a pressure difference (i.e., the cross-passage pressure gradient) between a suction surface of one adjacent blade and a pressure surface of other adjacent blade upstream of the recessed peak, thereby reducing the secondary flow which subsequently climbs up the suction surface of the one adjacent blade. The protruding surface portion may enable an increase in the pressure difference (i.e., the cross-passage pressure gradient) between the suction surface of the one adjacent blade and the pressure surface of the other adjacent blade downstream of the protruding peak, thereby increasing the secondary flow close to a trailing edge of the one adjacent blade. This may reduce trailing edge corner separation as the secondary flow is able to follow a shape of the suction surface of the one adjacent blade.

In some embodiments, the protruding peak of the protruding surface portion is disposed at the first longitudinal edge. The recessed peak of the recessed surface portion is disposed at the second longitudinal edge. The aforementioned positions of the protruding peak of the protruding surface portion and the recessed peak of the recessed surface portion may allow optimal manipulation of the secondary flow.

In some embodiments, the outer radial surface defines a nominal plane extending between the leading edge and the trailing edge and forming a part of the surface of revolution about the central axis. The protruding surface portion extends radially outwardly from the nominal plane by a maximum outward radial extent at the protruding peak of the protruding surface portion. The maximum outward radial extent of the protruding surface portion is less than or equal to 5% of the maximum axial length of the outer radial surface. This may allow manipulation of the secondary flow to generate the aforementioned aerodynamic effects.

In some embodiments, the recessed surface portion extends radially inwardly from the nominal plane by a maximum inward radial extent at the recessed peak of the recessed surface portion. The maximum inward radial extent of the recessed surface portion is less than or equal to 5% of the maximum axial length of the outer radial surface. This may allow manipulation of the secondary flow to generate the aforementioned aerodynamic effects.

In some embodiments, for a circumferential cross-section axially disposed between the first nominal surface portion and the second nominal surface portion, a maximum outward radial offset of the protruding surface portion with respect to the nominal plane is disposed at the first longitudinal edge. For the circumferential cross-section axially disposed between the first nominal surface portion and the second nominal surface portion, a maximum inward radial offset of the recessed surface portion with respect to the nominal plane is disposed at the second longitudinal edge. The aforementioned positions of the maximum outward radial offset and the maximum inward radial offset may allow optimal manipulation of the secondary flow.

In some embodiments, the outer radial surface extends at least circumferentially with respect to the central axis by a maximum circumferential width. Each of the protruding surface portion and the recessed surface portion extends at least circumferentially with respect to the central axis by a maximum circumferential extent. The maximum circumferential extent of each of the protruding surface portion and the recessed surface portion is less than or equal to 50% of the maximum circumferential width of the outer radial surface. This may allow optimal manipulation of the secondary flow to achieve the aforementioned aerodynamic effects.

In some embodiments, the protruding surface portion is fully continuous with the recessed surface portion at an interface line extending at least axially between the first nominal surface portion and the second nominal surface portion along the outer radial surface. This may allow manipulation of the secondary flow to achieve the aforementioned aerodynamic effects.

In some embodiments, the protruding surface portion is concave with respect to the central axis. The recessed surface portion is convex with respect to the central axis. Thus, the convex shape of the protruding surface portion may enable an increase in the pressure difference (i.e., the cross-passage pressure gradient) between the suction surface of the one adjacent blade and the pressure surface of the other adjacent blade. The concave shape of the recessed surface portion may enable a reduction in the pressure difference (i.e., the cross-passage pressure gradient) between the suction surface of the one adjacent blade and the pressure surface of the other adjacent bladed.

According to a second aspect, there is provided a rotor assembly for a gas turbine engine. The rotor assembly includes a rotor disc and a plurality of blades coupled to the rotor disc and angularly spaced apart from each other. The rotor assembly further includes a plurality of annulus fillers according to the first aspect. Each of the plurality of annulus fillers bridges a gap between corresponding adjacent blades from the plurality of blades. The coupling portion of each annulus filler is coupled to the rotor disc.

In some embodiments, each blade includes a blade leading edge, a blade trailing edge spaced apart from the blade leading edge, a pressure surface extending between the blade leading edge and the blade trailing edge, and a suction surface extending between the blade leading edge and the blade trailing edge opposite to the pressure surface. Each blade defines a blade chord length between the blade leading edge and the blade trailing edge at a radial span disposed at the outer radial surface of the annulus filler adjacent to the suction surface. A minimum axial distance between the blade leading edge and each of the protruding surface portion and the recessed surface portion is greater than or equal to 30% of the blade chord length. This may allow manipulation of the secondary flow to generate the aforementioned aerodynamic effects.

In some embodiments, a maximum axial distance between the blade leading edge and each of the protruding surface portion and the recessed surface portion is less than or equal to 75% of the blade chord length. This may allow manipulation of the secondary flow to generate the aforementioned aerodynamic effects.

The aforementioned positions of the protruding surface portion and the recessed surface portion with respect to the adjacent blades (i.e., the minimum axial distance and the maximum axial distance) may provide optimal manipulation of the secondary flow.

In some embodiments, the first longitudinal edge is disposed adjacent to the suction surface of one adjacent blade from the plurality of blades and the second longitudinal edge is disposed adjacent to the pressure surface of other adjacent blade from the plurality of blades. Thus, the protruding surface portion extending circumferentially from the first longitudinal edge and the recessed surface portion extending circumferentially from the second longitudinal edge may allow manipulation of the secondary flow to generate the aforementioned aerodynamic effects between the suction surface of the one adjacent blade and the pressure surface of the other adjacent blade.

In some embodiments, the maximum axial extent of each of the protruding surface portion and the recessed surface portion is less than or equal to 45% of the blade chord length. This may allow optimal manipulation of the secondary flow to achieve the aforementioned aerodynamic effects.

In some embodiments, the maximum outward radial extent of the protruding surface portion is less than or equal to 5% of the blade chord length. This may allow optimal manipulation of the secondary flow to achieve the aforementioned aerodynamic effects.

In some embodiments, the maximum inward radial extent of the recessed surface portion is less than or equal to 5% of the blade chord length. This may allow optimal manipulation of the secondary flow to achieve the aforementioned aerodynamic effects.

According to a third aspect, there is provided a gas turbine engine including at least one annulus filler of the first aspect or a rotor assembly of the second aspect.

According to a fourth aspect, there is provided a gas turbine engine including an engine core and a fan disposed upstream of the core engine. The fan includes a rotor assembly of the second aspect.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or a fan case.

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹ s or 80 Nkg⁻¹s. The specific thrust may be in an inclusive range bounded by any two of the values in the previous sentence (i.e. the values may form upper or lower bounds), for example in the range of from 80 Nkg⁻¹ s to 100 Nkg⁻¹s, or 85 Nkg⁻¹ s to 95 Nkg⁻¹s. Such engines may be particularly efficient in comparison with conventional gas turbine engines.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre.

The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the drawings, in which:

FIG. 1 is a sectional side view of a gas turbine engine;

FIG. 2 is a partial schematic front perspective view of a rotor assembly of the gas turbine engine of FIG. 1;

FIG. 3 is a schematic front perspective view of an annulus filler of the rotor assembly;

FIG. 4 is a schematic right-side view of the annulus filler of FIG. 3;

FIG. 5 is a schematic left-side view of the annulus filler of FIGS. 3 and 4;

FIG. 6 is a schematic sectional perspective view of the annulus filler taken along a section line P-P′ shown in FIG. 4;

FIG. 7 is a schematic graph illustrating a curve representing variation of a radial distance between an outer radial surface of an outer lid of the annulus filler and a nominal plane with respect to a circumferential distance from a second longitudinal edge of the outer lid in a circumferential cross-section;

FIG. 8 is a schematic graph illustrating multiple curves representing variation of a radial distance between a first longitudinal edge of the outer lid and the nominal plane with respect to an axial distance from a proximal end of a protruding surface portion of the outer radial surface;

FIG. 9 is a schematic top view of the annulus filler of FIGS. 3 to 6 disposed between adjacent blades of the rotor assembly.

### DETAILED DESCRIPTION

Aspects and embodiments of the present disclosure will now be discussed with reference to the accompanying figures. Further aspects and embodiments will be apparent to those skilled in the art.

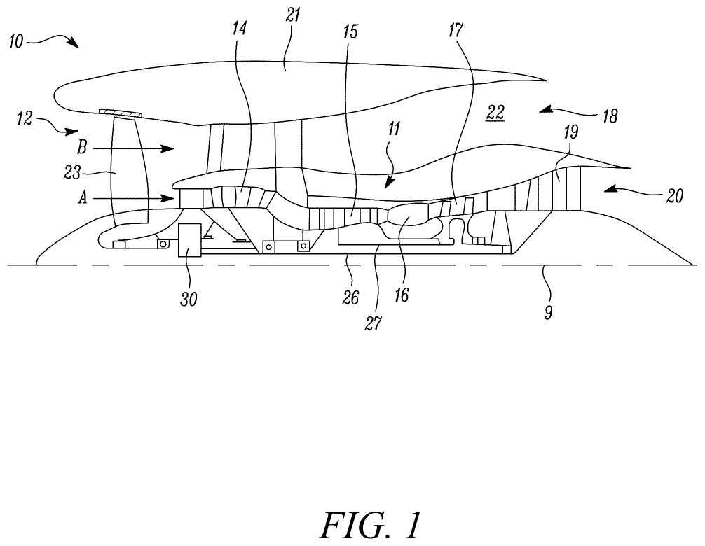

FIG. 1 illustrates a gas turbine engine 10 having a principal rotational axis 9. The gas turbine engine 10 comprises an air intake 12 and a propulsive fan 23 that generates two airflows: a core airflow A and a bypass airflow B. The gas turbine engine 10 further comprises an engine core 11 that receives the core airflow A. In some embodiments, the fan 23 is disposed upstream of the engine core 11. The engine core 11 comprises, in axial flow series, a low pressure compressor 14, a high pressure compressor 15, a combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting core shaft 27. The fan 23 generally provides the majority of the propulsive thrust. The epicyclic gearbox 30 is a reduction gearbox.

Note that the terms “low pressure turbine” and “low pressure compressor” as used herein may be taken to mean the lowest pressure turbine stages and lowest pressure compressor stages (i.e., not including the fan 23), respectively, and/or the turbine and compressor stages that are connected together by the interconnecting core shaft 27 with the lowest rotational speed in the gas turbine engine 10 (i.e., not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

Other gas turbine engines to which the present disclosure may be applied may have alternative configurations. For example, such engines may have an alternative number of compressors and/or turbines, and/or an alternative number of interconnecting shafts. By way of further example, the gas turbine engine 10 shown in FIG. 1 has a split flow nozzle 18, 20 meaning that the flow through the bypass duct 22 has its own nozzle 18 that is separate to and radially outside the core exhaust nozzle 20. However, this is not limiting, and any aspect of the present disclosure may also apply to engines in which the flow through the bypass duct 22 and the flow through the engine core 11 are mixed, or combined, before (or upstream of) a single nozzle, which may be referred to as a mixed flow nozzle. One or both nozzles (whether mixed or split flow) may have a fixed or variable area.

Whilst the described example relates to a turbofan engine, the disclosure may apply, for example, to any type of gas turbine engine, such as an open rotor (in which the fan stage is not surrounded by a nacelle), or a turboprop engine, for example. In some arrangements, the gas turbine engine 10 may not comprise the epicyclic gearbox 30.

The geometry of the gas turbine engine 10, and components thereof, is defined by a conventional axis system, comprising an axial direction (which is aligned with the principal rotational axis 9), a radial direction (in the bottom-to-top direction in FIG. 1), and a circumferential direction (perpendicular to the page in the FIG. 1 view). The axial, radial, and circumferential directions are mutually perpendicular.

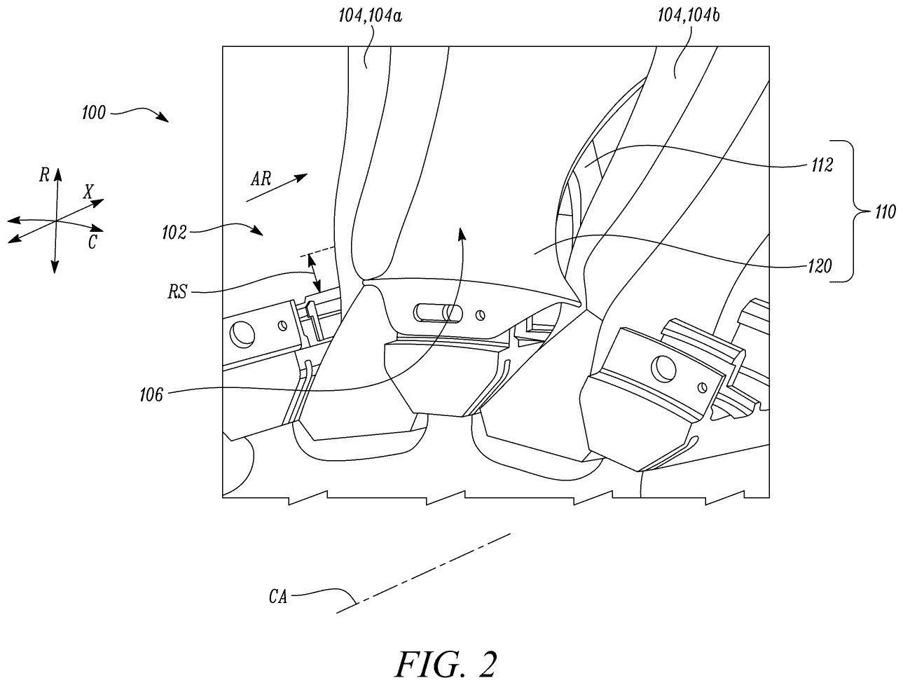

FIG. 2 is a partial schematic front perspective view of a rotor assembly 100 of the gas turbine engine 10 (shown in FIG. 1). Referring to FIGS. 1 and 2, in some embodiments, the fan 23 includes the rotor assembly 100. In some other embodiments, the rotor assembly 100 may be a part of the low pressure compressor 14 or other compressors of the gas turbine engine 10, e.g., the high pressure compressor 15. The rotor assembly 100 includes a rotor disc 102. Specifically, FIG. 2 shows a portion of a radially outer surface of the rotor disc 102 of the rotor assembly 100.

An axial direction X is defined that is aligned with a central axis CA (or the principal rotational axis 9) of the gas turbine engine 10. As used herein, terms that refer to an axial direction, such as “axially disposed”, “axially extends”, “axially spaced apart”, “axially proximal”, “axially between”, “extend at least axially”, “extend axially”, and “extending axially” are with respect to the axial direction X. A radial direction R is defined with respect to the central axis CA perpendicular to the axial direction X. As used herein, terms that refer to a radial direction, such as “radially outer”, “radially outside”, “radially inner”, “radially extends”, “radially inwards”, “radially outwards”, “radially outwardly”, “radially spaced apart”, “radially proximal”, “extend at least radially”, “extend radially”, and “extending radially” are with respect to the radial direction R. A circumferential direction C is defined with respect to the central axis CA. As used herein, terms that refer to a circumferential direction, such as “circumferentially extends”, “circumferentially extending”, “circumferentially surrounding”, “circumferentially inclined”, “circumferentially with respect to”, “circumferentially disposed”, “extend at least circumferentially”, “extend circumferentially”, and “extending circumferentially” are with respect to the circumferential direction C.

The rotor assembly 100 further includes a plurality of blades 104 coupled to the rotor disc 102 and angularly spaced apart from each other. Specifically, the plurality of blades 104 are angularly spaced apart from each other along the circumferential direction C. In the illustrated embodiment of FIG. 2, the blades 104a, 104b from the plurality of blades 104 are shown for the purpose of illustration. In some embodiments, the rotor disc 102 may include retention grooves (not shown) for retaining a root portion (not shown) of the corresponding blade 104 from the plurality of blades 104. The retention grooves may be straight and extend in the axial direction X.

In some embodiments, the rotor assembly 100 further includes a plurality of annulus fillers 110. Only one annulus filler 110 from the plurality of annulus fillers 110 is shown in FIG. 2 for the purpose of illustration. Each of the plurality of annulus fillers 110 bridges a gap 106 between corresponding adjacent blades 104 from the plurality of blades 104. Specifically, each of the plurality of annulus fillers 110 bridges the gap 106 disposed at the radially outer surface of the rotor disc 102 between the corresponding adjacent blades 104. The term “plurality of annulus fillers 110” is interchangeably referred to hereinafter as the “annulus fillers 110”.

In some embodiments, the plurality of annulus fillers 110 may ensure a smooth surface for an air AR drawn through the gas turbine engine 10 to flow over as the air AR passes through the rotor assembly 100. In some embodiments, the annulus filler 110 may be made of carbon fibre reinforced composite material. Other possible materials may include, but are not limited to, moulded polymer, fibre-reinforced polymer (e.g., glass, carbon, aramid, or polyurethane fibres in a thermosetting or thermoplastic polymer matrix), machined metal, extruded metal, cast metal, etc. Typical examples of metals/alloys may include, but are not limited to, aluminium, titanium, and magnesium alloys. However, other polymer-based composite and metallic materials may also be used based on application requirements. In some embodiments, the annulus filler 110 may be integrally formed as a one-piece component.

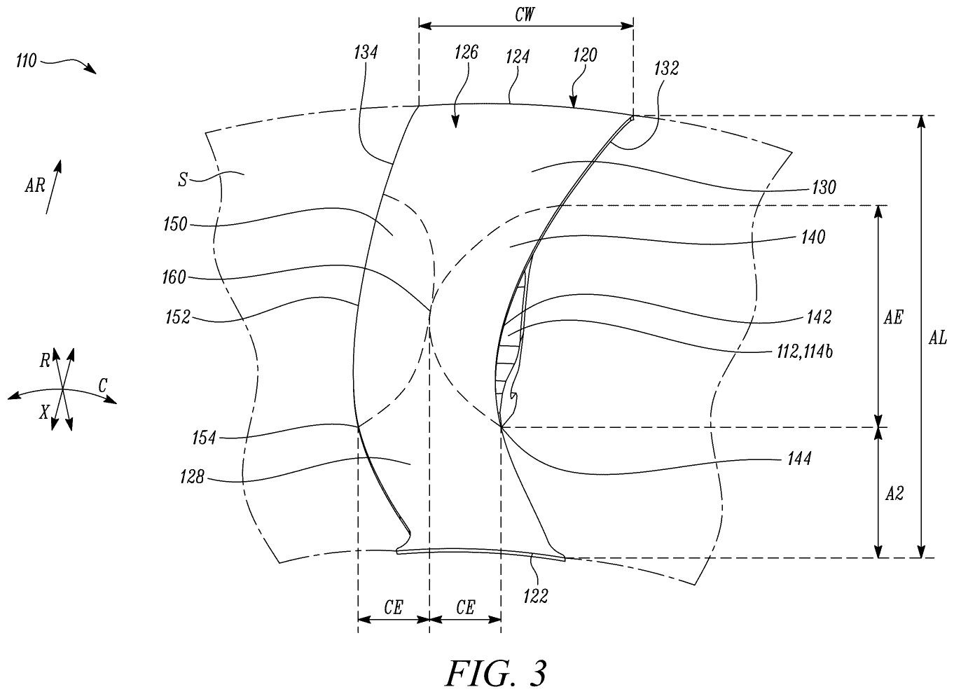

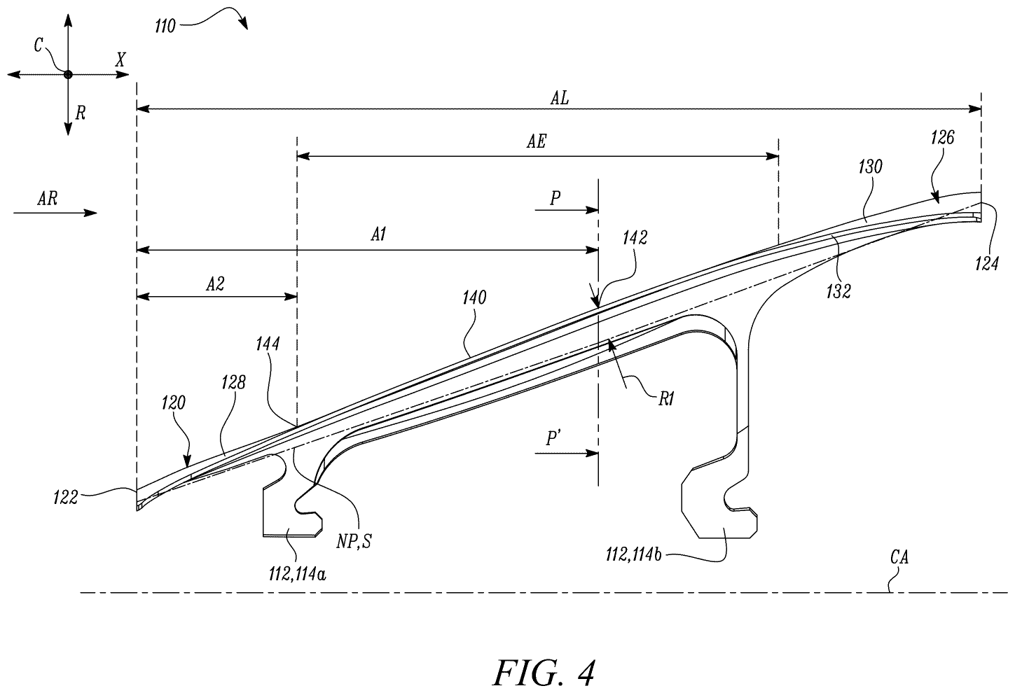

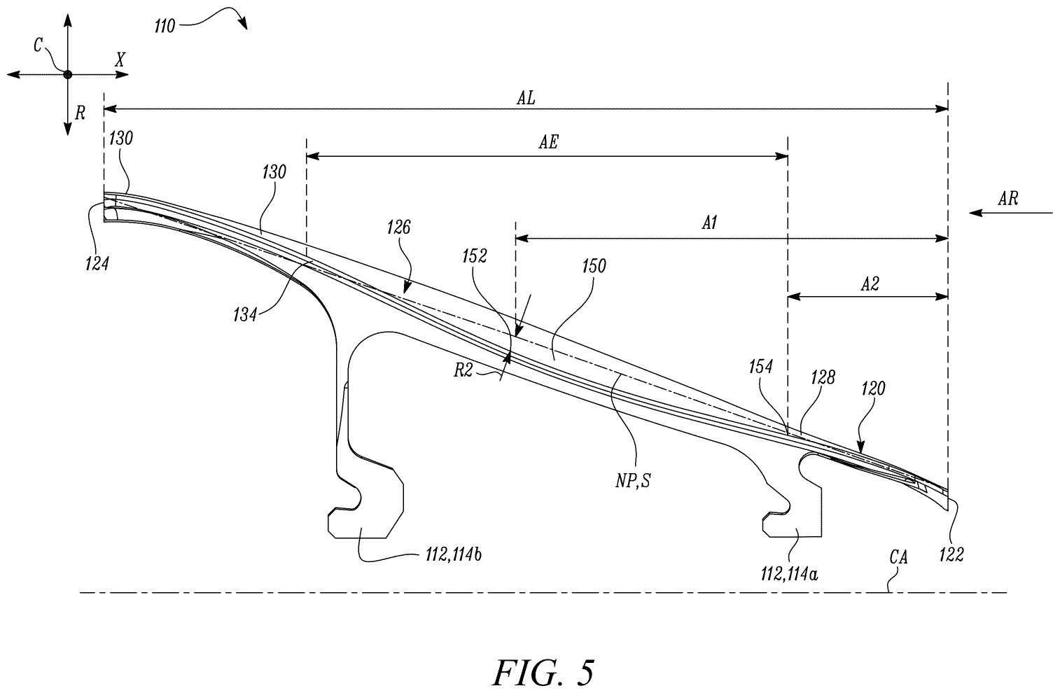

FIG. 3 is a schematic perspective view of the annulus filler 110 of the rotor assembly 100. FIGS. 4 and 5 are schematic right-side and left-side views of the annulus filler 110, respectively. Referring to FIGS. 2-5, the annulus filler 110 is mountable to the rotor disc 102 of the gas turbine engine 10 (shown in FIG. 1). The annulus filler 110 includes a coupling portion 112 connectable to the rotor disc 102. Specifically, the coupling portion 112 of each annulus filler 110 is coupled to the rotor disc 102.

In some embodiments, the coupling portion 112 may include axially spaced apart support structures 114a, 114b (shown in FIGS. 3-5), e.g., hooks, engaging structures, etc., which are connectable to complementary securing members (not shown) on the rotor disc 102. In some embodiments, the support structures 114a, 114b may allow the annulus filler 110 to be installed on the rotor disc 102 in a tool-less manner without requiring for any additional parts. In some embodiments, the support structures 114a, 114b may transfer centrifugal and/or radial loads to the securing members on the rotor disc 102 when the rotor disc 102 spins. In alternative configurations, the annulus filler 110 may have a single support structure or more than two such support structures.

The annulus filler 110 further includes an outer lid 120 coupled to the coupling portion 112 and extending axially, radially, and circumferentially with respect to the central axis CA. The outer lid 120 and the rotor disc 102 may have a common central axis, i.e., the central axis CA. In some embodiments, the outer lid 120 extends axially along the axial direction X, radially along the radial direction R, and circumferentially along the circumferential direction C. The outer lid 120 is configured to be at least partially and circumferentially disposed between two adjacent blades 104 connected to the rotor disc 102. In the illustrated embodiment of FIG. 2, the outer lid 120 is at least partially and circumferentially disposed between the adjacent blades 104a, 104b connected to the rotor disc 102. Each support structure 114a, 114b (shown in FIGS. 3-5) extends radially inwardly from the outer lid 120 with respect to the central axis CA.

The outer lid 120 includes a leading edge 122 extending at least circumferentially with respect to the central axis CA. The leading edge 122 may be an upstream circumferential edge of the outer lid 120 with respect to a direction of flow of the air AR. The outer lid 120 further includes a trailing edge 124 axially spaced apart from the leading edge 122 and extending at least circumferentially with respect to the central axis CA. The trailing edge 124 may be a downstream circumferential edge of the outer lid 120 with respect to the direction of flow of the air AR.

The outer lid 120 further includes a first longitudinal edge 132 extending at least axially between the leading edge 122 and the trailing edge 124 with respect to the central axis CA. In some embodiments, the outer lid 120 further includes a second longitudinal edge 134 circumferentially spaced apart from the first longitudinal edge 132 with respect to the central axis CA. The second longitudinal edge 134 extends at least axially between the leading edge 122 and the trailing edge 124 with respect to the central axis CA.

The outer lid 120 further includes an outer radial surface 126 configured to contact the air AR drawn through the gas turbine engine 10 (shown in FIG. 1). The outer radial surface 126 is delimited by the leading edge 122, the trailing edge 124, the first longitudinal edge 132, and the second longitudinal edge 134. In other words, the outer radial surface 126 engages the air AR as the air AR is drawn through the rotor assembly 100. In some embodiments, a portion of the air AR drawn through the gas turbine engine 10 may move along the outer radial surface 126. The outer radial surface 126 may allow smooth flow of the air AR over the annulus filler 110.

The outer radial surface 126 includes a first nominal surface portion 128 extending axially from the leading edge 122 towards the trailing edge 124 and extending circumferentially between the first longitudinal edge 132 and the second longitudinal edge 134. The first nominal surface portion 128 is formed as a first part of a surface of revolution S (shown in FIG. 3) about the central axis CA. The surface of revolution S is shown with a dotted line in FIG. 3.

In some embodiments, the surface of revolution S may be a three-dimensional surface (3D surface) generated by rotating a curve lying on a plane about an axis of rotation (e.g., the central axis CA) that lies on the same plane. The term “surface of revolution” generally refers to any surface generated by rotating the curve by a predetermined angular rotation about the axis of rotation (e.g., the central axis CA). As used herein, the term “curve” generally refers to a predetermined, continuous, two-dimensional, concatenation of line segments and/or arcs that has a beginning point and an end point. The beginning and end points of the curve may lie on the same plane. In some embodiments, the surface of revolution S may represent a portion of a frustoconical surface about the central axis CA. In some embodiments, the first nominal surface portion 128 of the outer radial surface 126 of each of the plurality of annulus fillers 110 may be formed as a respective part of the surface of revolution S.

The outer radial surface 126 further includes a second nominal surface portion 130 axially spaced apart from the first nominal surface portion 128. The second nominal surface portion 130 extends axially from the trailing edge 124 towards the leading edge 122 and extends circumferentially between the first longitudinal edge 132 and the second longitudinal edge 134. The second nominal surface portion 130 is formed as a second part of the surface of revolution S about the central axis CA. In some embodiments, the second nominal surface portion 130 of the outer radial surface 126 of each of the plurality of annulus fillers 110 may be formed as a respective part of the surface of revolution S.

The outer radial surface 126 further includes a protruding surface portion 140 (shown in FIGS. 3 and 4) extending circumferentially from the first longitudinal edge 132 and axially disposed between the first nominal surface portion 128 and the second nominal surface portion 130. The protruding surface portion 140 is contiguous with each of the first nominal surface portion 128 and the second nominal surface portion 130. As shown in FIG. 4, the protruding surface portion 140 further extends radially outwardly from each of the first nominal surface portion 128 and the second nominal surface portion 130 with respect to the central axis CA. In some embodiments, the protruding surface portion 140 is concave with respect to the central axis CA.

The outer radial surface 126 further includes a recessed surface portion 150 (shown in FIGS. 3 and 5) extending circumferentially from the second longitudinal edge 134 and axially disposed between the first nominal surface portion 128 and the second nominal surface portion 130. The recessed surface portion 150 is disposed adjacent to the protruding surface portion 140 and is contiguous with each of the first nominal surface portion 128 and the second nominal surface portion 130. As shown in FIG. 5, the recessed surface portion 150 further extends radially inwardly from each of the first nominal surface portion 128 and the second nominal surface portion 130 with respect to the central axis CA. The recessed surface portion 150 is convex with respect to the central axis CA.

In some embodiments, the protruding surface portion 140 is fully continuous with the recessed surface portion 150 at an interface line 160 (shown in FIG. 3) extending at least axially between the first nominal surface portion 128 and the second nominal surface portion 130 along the outer radial surface 126. However, in some other embodiments, the protruding surface portion 140 may be circumferentially spaced apart from the recessed surface portion 150 with respect to the central axis CA. In such cases, the interface line 160 may not exist.

The outer radial surface 126 of the outer lid 120 includes the protruding surface portion 140 extending radially outwardly from each of the first nominal surface portion 128 and the second nominal surface portion 130 with respect to the central axis CA and the recessed surface portion 150 extending radially inwardly from each of the first nominal surface portion 128 and the second nominal surface portion 130 with respect to the central axis CA. The protruding surface portion 140 and the recessed surface portion 150 may allow a non-axisymmetric profile for the radially outer surface of the rotor disc 102, thereby influencing the air AR drawn through the gas turbine engine 10 (shown in FIG. 1) as the air AR passes over the outer radial surface 126 of the outer lid 120. Specifically, the protruding surface portion 140 and the recessed surface portion 150 may provide a circumferentially variable surface to the outer lid 120, thereby influencing the portion of the air AR flowing over the outer radial surface 126 of the outer lid 120.

In some embodiments, the shape of the outer lid 120 may result in variation of cross-passage pressure gradients and an aerodynamic loading of the adjacent blades 104. Specifically, the shape of the outer lid 120 may influence a topology of a secondary flow (generated by cross-passage pressure gradients) at a blade hub of the adjacent blades 104. More specifically, the aforementioned aerodynamic behaviour may influence an axial location where a vortical structure of the secondary flow is formulated, a radial position of the vortical structure, and an intensity of the vortical structure, thereby mitigating dissipative losses caused by the secondary flows generated between the adjacent blades 104.

The secondary flow may travel downstream to subsequent rotor stages. The outer radial surface 126 of the outer lid 120 may not only increase an efficiency of a blade root component of the blades 104 at the blade hub but also enables reduction in induced forced vibrations of the subsequent rotor stages. Thus, the annulus filler 110 of the present disclosure may improve an efficiency of the gas turbine engine 10 (shown in FIG. 1). The aforementioned desirable effects work at all operating conditions of the gas turbine engine 10 and are most effective during cruise conditions, which is a major part of engine operational cycle.

In some embodiments, the outer radial surface 126 extends at least axially with respect to the central axis CA by a maximum axial length AL. Each of the protruding surface portion 140 and the recessed surface portion 150 extends at least axially with respect to the central axis CA by a maximum axial extent AE. The maximum axial extent AE of each of the protruding surface portion 140 and the recessed surface portion 150 is at most 45% of the maximum axial length AL of the outer radial surface 126. Each of the protruding surface portion 140 and the recessed surface portion 150 may extend at least axially to enable optimal manipulation of the secondary flow at the blade hub of the adjacent blades 104.

In some embodiments, the outer radial surface 126 extends at least circumferentially with respect to the central axis CA by a maximum circumferential width CW. Each of the protruding surface portion 140 and the recessed surface portion 150 extends at least circumferentially with respect to the central axis CA by a maximum circumferential extent CE. The maximum circumferential extent CE of each of the protruding surface portion 140 and the recessed surface portion 150 is less than or equal to 50% of the maximum circumferential width CW of the outer radial surface 126. This may allow optimal manipulation of the secondary flow to generate the aforementioned aerodynamic effects.

In some embodiments, an axial distance A2 between the leading edge 122 of the outer lid 120 and a proximal end 144 of the protruding surface portion 140 or a proximal end 154 of the recessed surface portion 150 with respect to the central axis CA is from 30% to 75% of the maximum axial length AL of the outer radial surface 126. This may allow manipulation of the secondary flow to generate the aforementioned aerodynamic effects.

In some embodiments, the outer radial surface 126 defines a nominal plane NP (shown in FIGS. 4 and 5) extending between the leading edge 122 and the trailing edge 124 and forming a part of the surface of revolution S about the central axis CA. The protruding surface portion 140 includes a protruding peak 142 (shown in FIGS. 3 and 4) that is radially outermost with respect to the central axis CA. In some embodiments, the protruding peak 142 of the protruding surface portion 140 is disposed at the first longitudinal edge 132.

The recessed surface portion 150 includes a recessed peak 152 (shown in FIGS. 3 and 5) that is radially innermost with respect to the central axis CA. In some embodiments, the recessed peak 152 of the recessed surface portion 150 is disposed at the second longitudinal edge 134. In the illustrated embodiments, the recessed peak 152 of the recessed surface portion 150 is circumferentially in-line with the protruding peak 142 of the protruding surface portion 140. However, in other embodiments, the recessed peak 152 may or may not be circumferentially in-line with the protruding peak 142. An axial distance A1 (shown in FIGS. 4 and 5) between the leading edge 122 of the outer lid 120 and each of the protruding peak 142 and the recessed peak 152 with respect to the central axis CA is from 30% to 75% of the maximum axial length AL of the outer radial surface 126. The axial distance A1 may provide optimal manipulation of the secondary flow.

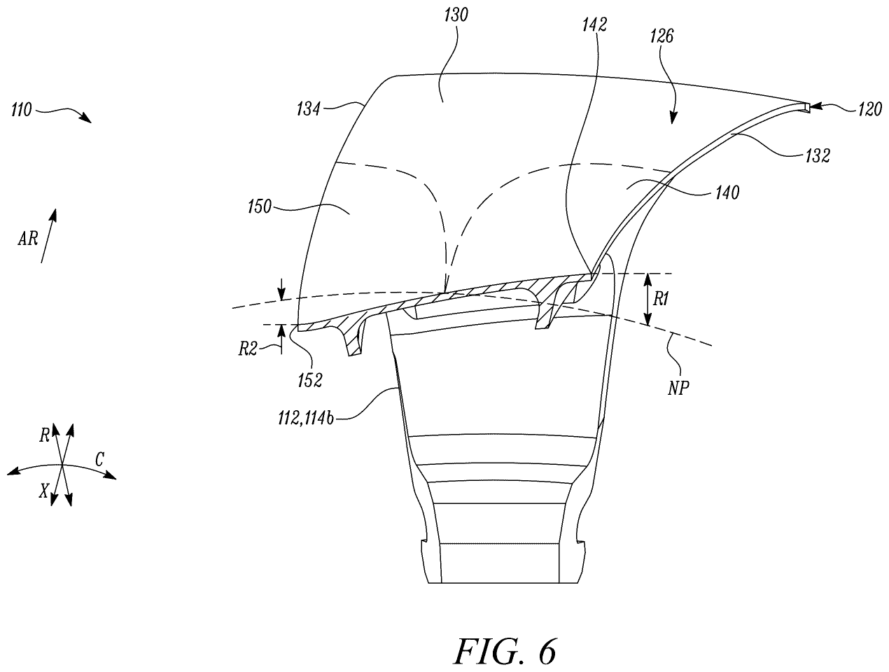

FIG. 6 is a schematic sectional perspective view of the annulus filler 110 taken along a section line P-P′ shown in FIG. 4. Referring to FIGS. 4 and 6, in some embodiments, the protruding surface portion 140 extends radially outwardly from the nominal plane NP by a maximum outward radial extent R1 at the protruding peak 142 of the protruding surface portion 140. The maximum outward radial extent R1 of the protruding surface portion 140 is less than or equal to 5% of the maximum axial length AL of the outer radial surface 126. This may allow manipulation of the secondary flow to generate the aforementioned aerodynamic effects.

Referring to FIGS. 5 and 6, in some embodiments, the recessed surface portion 150 extends radially inwardly from the nominal plane NP by a maximum inward radial extent R2 at the recessed peak 152 of the recessed surface portion 150. The maximum inward radial extent R2 of the recessed surface portion 150 is less than or equal to 5% of the maximum axial length AL of the outer radial surface 126. This may allow manipulation of the secondary flow to generate the aforementioned aerodynamic effects. A magnitude of the maximum outward radial extent R1 (shown in FIGS. 4 and 6) may or may not be equal to a magnitude of the maximum inward radial extent R2.

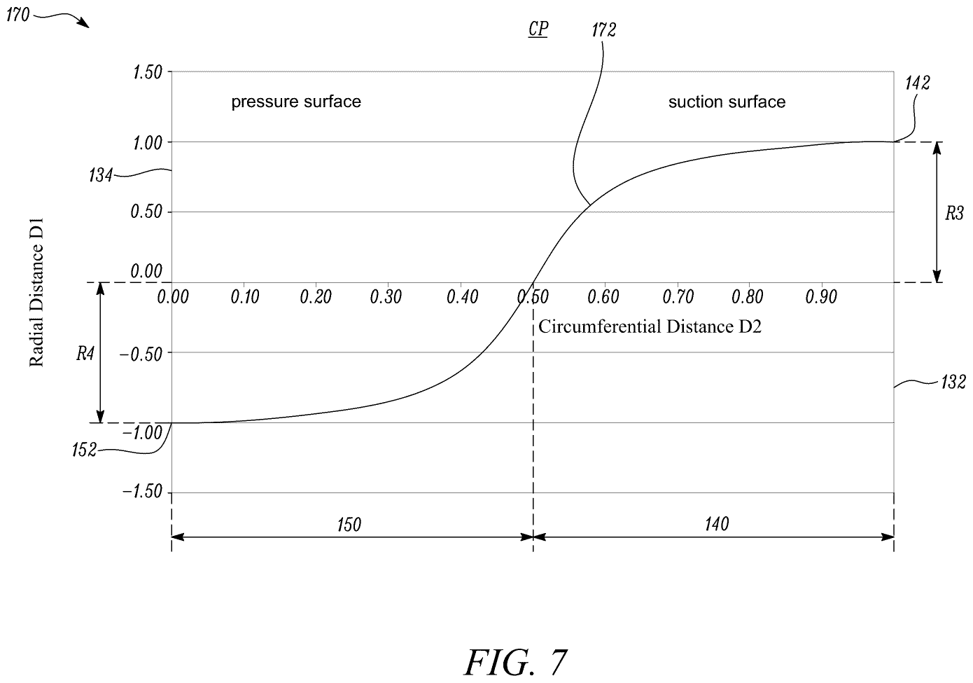

FIG. 7 is a schematic graph 170 illustrating a curve 172 defining the outer radial surface 126 (shown in FIGS. 2-6) of the outer lid 120 (shown in FIGS. 2-6) at a circumferential cross-section CP axially disposed between the first nominal surface portion 128 and the second nominal surface portion 130. Specifically, the curve 172 shows variation of a radial distance D1 between the outer radial surface 126 of the outer lid 120 and the nominal plane NP (shown in FIGS. 4-6) with respect to a circumferential distance D2 from the second longitudinal edge 134 of the outer lid 120 in the circumferential cross-section. The radial distance D1 is shown along the vertical axis or ordinate of the graph 170 in arbitrary units. The radial distance D1 is positive when the radial distance D1 is radially outward of the nominal plane NP and negative when the radial distance D1 is radially inward of the nominal plane NP. Further, the circumferential distance D2 is shown along the horizontal axis or abscissa of the graph 170 as a fraction of the maximum circumferential width CW (shown in FIG. 3) of the outer radial surface 126.

In the illustrated graph 170, the circumferential cross-section CP passes through each of the protruding peak 142 of the protruding surface portion 140 and the recessed peak 152 of the recessed surface portion 150 of the outer radial surface 126. Thus, the circumferential cross-section CP may align with the section line P-P′ shown in FIG. 4. However, the circumferential cross-section CP may or may not align with the protruding peak 142 of the protruding surface portion 140 and the recessed peak 152 of the recessed surface portion 150.

In some embodiments, for the circumferential cross-section CP, a maximum outward radial offset R3 of the protruding surface portion 140 with respect to the nominal plane NP is disposed at the first longitudinal edge 132. In some embodiments, for the circumferential cross-section CP, a maximum inward radial offset R4 of the recessed surface portion 150 with respect to the nominal plane NP is disposed at the second longitudinal edge 134.

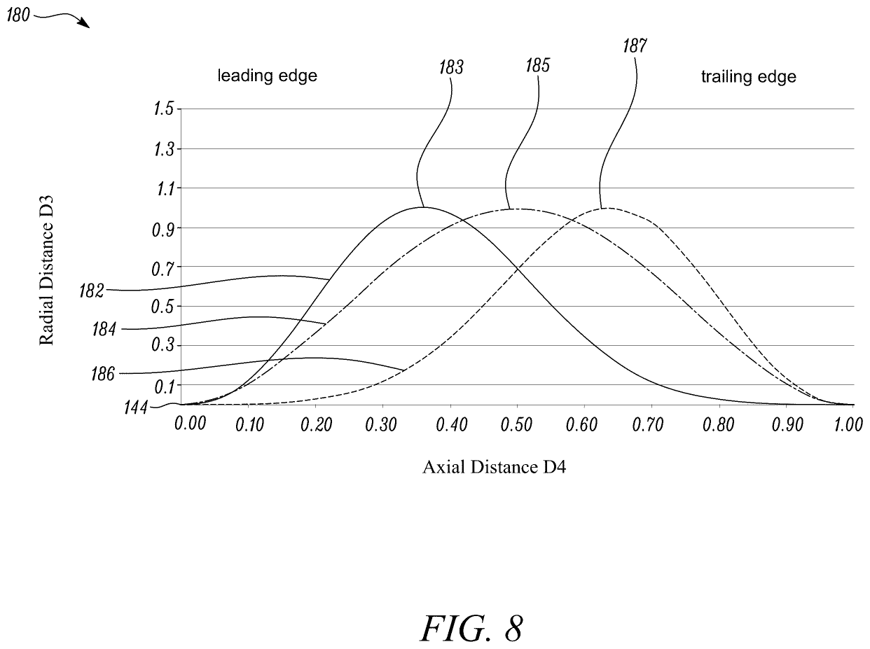

FIG. 8 is a schematic graph 180 illustrating curves 182, 184, 186 representing the first longitudinal edge 132 (shown in FIGS. 3-6) of the outer lid 120 (shown in FIGS. 2-6). Specifically, the curves 182, 184, 186 show variation of a radial distance D3 between the first longitudinal edge 132 and the nominal plane NP (shown in FIGS. 4-6) with respect to an axial distance D4 from the proximal end 144 (shown in FIGS. 3 and 4) of protruding surface portion 140. The radial distance D3 is shown along the vertical axis or ordinate of the graph 180 in arbitrary units. Further, the axial distance D4 is shown along the horizontal axis or abscissa of the graph 180 as a fraction of the maximum axial extent AE (shown in FIG. 3) of the protruding surface portion 140.

Points 183, 185, 187 represent the protruding peak 142 (shown in FIGS. 3-4 and 6) disposed on the corresponding curves 182, 184, 186 at different axial locations. The curves 182, 184, 186 therefore have different axial locations of the protruding peak. For example, the point 185 is disposed at 50% of the maximum axial extent AE. The graph 180 shows that the axial distance D4 of the protruding peak 142 of the protruding surface portion 140 (shown in FIGS. 2-4 and 6) may vary based on application requirements. The profiles of the curves 182, 184, 186 change based on the different axial locations of the protruding peak 142.

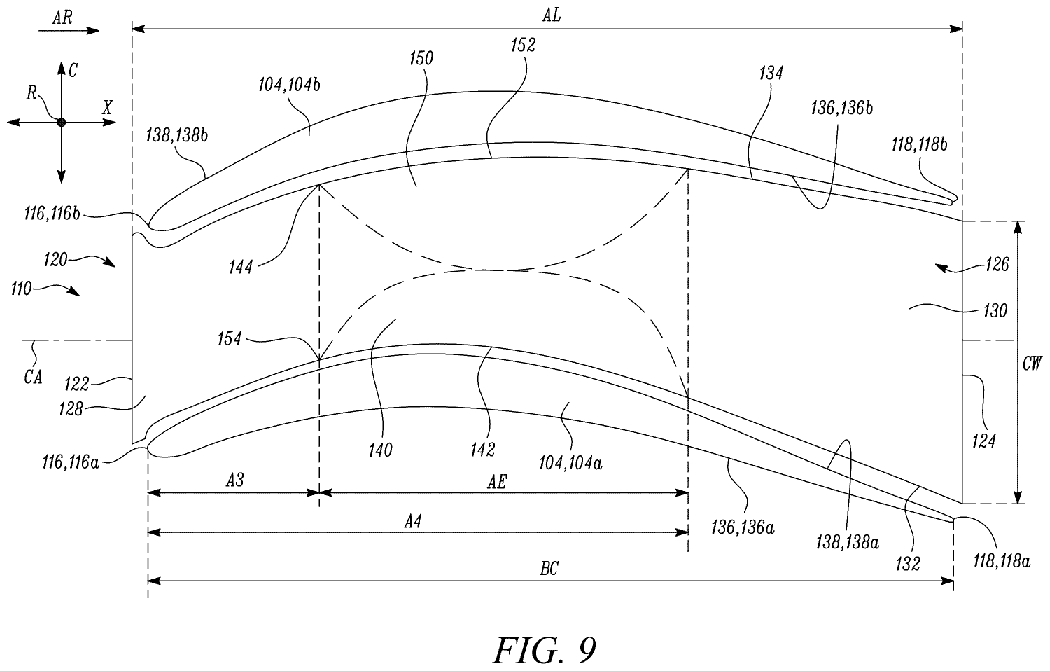

FIG. 9 is a schematic top view of the annulus filler 110 disposed between corresponding adjacent blades 104 of the rotor assembly 100 (shown in FIG. 2). In the illustrated embodiment of FIG. 9, the blades 104a, 104b are shown for the purpose of illustration. In some embodiments, each blade 104 includes a blade leading edge 116, a blade trailing edge 118 spaced apart from the blade leading edge 116, a pressure surface 136 extending between the blade leading edge 116 and the blade trailing edge 118, and a suction surface 138 extending between the blade leading edge 116 and the blade trailing edge 118 opposite to the pressure surface 136. In some embodiments, the first longitudinal edge 132 is disposed adjacent to the suction surface 138 of one adjacent blade 104 from the plurality of blades 104 and the second longitudinal edge 134 is disposed adjacent to the pressure surface 136 of other adjacent blade 104 from the plurality of blades 104.

In the illustrated embodiment of FIG. 9, the blade 104a includes the blade leading edge 116a, the blade trailing edge 118a, the pressure surface 136a, and the suction surface 138a. Similarly, the blade 104b includes the blade leading edge 116b, the blade trailing edge 118b, the pressure surface 136b, and the suction surface 138b. Further, the first longitudinal edge 132 is disposed adjacent to the suction surface 138a of the adjacent blade 104a and the second longitudinal edge 134 is disposed adjacent to the pressure surface 136b of the adjacent blade 104b.

In the illustrated embodiment, the recessed surface portion 150 may enable a reduction in a pressure difference (i.e., the cross-passage pressure gradient) between the suction surface 138a of the adjacent blade 104a and the pressure surface 136b of the adjacent blade 104b upstream of the recessed peak 152, thereby reducing the secondary flow which subsequently climbs up the suction surface 138a of the adjacent blade 104a. The protruding surface portion 140 may enable an increase in the pressure difference (i.e., the cross-passage pressure gradient) between the suction surface 138a of the adjacent blade 104a and the pressure surface 136b of the adjacent blade 104b downstream of the protruding peak 142, thereby increasing the secondary flow close to the blade trailing edge 118a of the adjacent blade 104a. This may reduce trailing edge corner separation as the secondary flow is able to follow a shape of the suction surface 138a of the adjacent blade 104a.

In some embodiments, each blade 104 (i.e., the blades 104a, 104b) defines a blade chord length BC between the blade leading edge 116 and the blade trailing edge 118 at a radial span RS (shown in FIG. 2) disposed at the outer radial surface 126 of the annulus filler 110 adjacent to the suction surface 138. As shown in FIG. 9, the blade 104a defines the blade chord length BC between the blade leading edge 116a and the blade trailing edge 118a. A minimum axial distance A3 between the blade leading edge 116 and each of the protruding surface portion 140 and the recessed surface portion 150 is greater than or equal to 30% of the blade chord length BC. Further, a maximum axial distance A4 between the blade leading edge 116 and each of the protruding surface portion 140 and the recessed surface portion 150 is less than or equal to 75% of the blade chord length BC. This may allow manipulation of the secondary flow to generate the aforementioned aerodynamic effects.

In some embodiments, the maximum axial extent AE of each of the protruding surface portion 140 and the recessed surface portion 150 is less than or equal to 45% of the blade chord length BC. In some embodiments, the maximum outward radial extent R1 (shown in FIGS. 4 and 6) of the protruding surface portion 140 is less than or equal to 5% of the blade chord length BC. Further, the maximum inward radial extent R2 (shown in FIGS. 5 and 6) of the recessed surface portion 150 is less than or equal to 5% of the blade chord length BC. This may allow optimal manipulation of the secondary flow to generate the aforementioned aerodynamic effects.

Referring to FIGS. 1-9, the protruding surface portion 140 and the recessed surface portion 150 of the outer radial surface 126 may allow a non-axisymmetric profile for the radially outer surface of the rotor disc 102. Specifically, the protruding surface portion 140 and the recessed surface portion 150 may provide a circumferentially variable surface to the outer lid 120, thereby influencing the air AR flowing over the outer radial surface 126 of the outer lid 120 of the annulus filler 110.

The shape of the outer lid 120 of the annulus filler 110 may result in a variation of the cross-passage pressure gradients and the aerodynamic loading of the adjacent blades 104. Specifically, the shape of the outer lid 120 may influence the topology of the secondary flow (generated by cross-passage pressure gradients) at the blade hub of the blades 104. More specifically, the aforementioned aerodynamic behaviour may influence an axial location where a vortical structure of the secondary flow is formulated, a radial position of the vortical structure, and an intensity of the vortical structure, thereby mitigating dissipative losses caused by the secondary flows generated between the adjacent blades 104. Thus, the annulus filler 110 of the present disclosure may improve an efficiency of the gas turbine engine 10.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1-16. (canceled)

17. An annulus filler for mounting to a rotor disc of a gas turbine engine, the annulus filler comprising:
a coupling portion connectable to the rotor disc; and
an outer lid coupled to the coupling portion and extending axially, radially, and circumferentially with respect to a central axis, wherein the outer lid is configured to be at least partially and circumferentially disposed between two adjacent blades connected to the rotor disc, the outer lid comprising:
a leading edge that extends at least circumferentially with respect to the central axis;
a trailing edge that is axially spaced apart from the leading edge and extending at least circumferentially with respect to the central axis;
a first longitudinal edge extending at least axially between the leading edge and the trailing edge with respect to the central axis;
a second longitudinal edge circumferentially spaced apart from the first longitudinal edge with respect to the central axis, wherein the second longitudinal edge extends at least axially between the leading edge and the trailing edge with respect to the central axis; and
an outer radial surface configured to contact an air drawn through the gas turbine engine, wherein the outer radial surface is delimited by the leading edge, the trailing edge, the first longitudinal edge, and the second longitudinal edge, the outer radial surface comprising:
a first nominal surface portion extending axially from the leading edge towards the trailing edge and extending circumferentially between the first longitudinal edge and the second longitudinal edge, wherein the first nominal surface portion is formed as a first part of a surface of revolution about the central axis;
a second nominal surface portion axially spaced apart from the first nominal surface portion, the second nominal surface portion extending axially from the trailing edge towards the leading edge and extending circumferentially between the first longitudinal edge and the second longitudinal edge, the second nominal surface portion is formed as a second part of the surface of revolution about the central axis;
a protruding surface portion extending circumferentially from the first longitudinal edge and axially disposed between the first nominal surface portion and the second nominal surface portion, wherein the protruding surface portion is contiguous with each of the first nominal surface portion and the second nominal surface portion; and
a recessed surface portion extending circumferentially from the second longitudinal edge and axially disposed between the first nominal surface portion and the second nominal surface portion, wherein the recessed surface portion is disposed adjacent to the protruding surface portion and is contiguous with each of the first nominal surface portion and the second nominal surface portion;
wherein each of the protruding surface portion and the recessed surface portion is configured to redirect the air drawn through the gas turbine engine.

18. The annulus filler of claim 17, wherein the outer radial surface extends at least axially with respect to the central axis by a maximum axial length, wherein each of the protruding surface portion and the recessed surface portion extends at least axially with respect to the central axis by a maximum axial extent, and wherein the maximum axial extent of each of the protruding surface portion and the recessed surface portion is at most 45% of the maximum axial length of the outer radial surface.

19. The annulus filler of claim 18, wherein an axial distance between the leading edge of the outer lid and a proximal end of the protruding surface portion or a proximal end of the recessed surface portion with respect to the central axis is from 30% to 75% of the maximum axial length of the outer radial surface.

20. The annulus filler of claim 18, wherein the protruding surface portion comprises a protruding peak that is radially outermost with respect to the central axis, wherein the recessed surface portion comprises a recessed peak that is radially innermost with respect to the central axis, and wherein an axial distance between the leading edge of the outer lid and each of the protruding peak and the recessed peak with respect to the central axis is from 30% to 75% of the maximum axial length of the outer radial surface.

21. The annulus filler of claim 20, wherein the protruding peak of the protruding surface portion is disposed at the first longitudinal edge, and wherein the recessed peak of the recessed surface portion is disposed at the second longitudinal edge.

22. The annulus filler of claim 20, wherein the outer radial surface defines a nominal plane extending between the leading edge and the trailing edge and forming a part of the surface of revolution about the central axis, wherein the protruding surface portion extends radially outwardly from the nominal plane by a maximum outward radial extent at the protruding peak of the protruding surface portion, and wherein the maximum outward radial extent of the protruding surface portion is less than or equal to 5% of the maximum axial length of the outer radial surface.

23. The annulus filler of claim 22, wherein the recessed surface portion extends radially inwardly from the nominal plane by a maximum inward radial extent at the recessed peak of the recessed surface portion, and wherein the maximum inward radial extent of the recessed surface portion is less than or equal to 5% of the maximum axial length of the outer radial surface.

24. The annulus filler of claim 17, wherein, for a circumferential cross-section axially disposed between the first nominal surface portion and the second nominal surface portion:
a maximum outward radial offset of the protruding surface portion with respect to the nominal plane is disposed at the first longitudinal edge; and
a maximum inward radial offset of the recessed surface portion with respect to the nominal plane is disposed at the second longitudinal edge.

25. The annulus filler of claim 17, wherein the outer radial surface extends at least circumferentially with respect to the central axis by a maximum circumferential width, wherein each of the protruding surface portion and the recessed surface portion extends at least circumferentially with respect to the central axis by a maximum circumferential extent, and wherein the maximum circumferential extent of each of the protruding surface portion and the recessed surface portion is less than or equal to 50% of the maximum circumferential width of the outer radial surface.

26. The annulus filler of claim 17, wherein the protruding surface portion is fully continuous with the recessed surface portion at an interface line extending at least axially between the first nominal surface portion and the second nominal surface portion along the outer radial surface.

27. The annulus filler of claim 17, wherein the protruding surface portion is concave with respect to the central axis, and wherein the recessed surface portion is convex with respect to the central axis.

28. A rotor assembly for a gas turbine engine, the rotor assembly comprising:
a rotor disc;
a plurality of blades coupled to the rotor disc and angularly spaced apart from each other; and
a plurality of annulus fillers according to claim 17, each of the plurality of annulus fillers bridging a gap between corresponding adjacent blades from the plurality of blades, wherein the coupling portion of each annulus filler is coupled to the rotor disc.

29. The rotor assembly of claim 28, wherein each blade comprises a blade leading edge, a blade trailing edge spaced apart from the blade leading edge, a pressure surface extending between the blade leading edge and the blade trailing edge, and a suction surface extending between the blade leading edge and the blade trailing edge opposite to the pressure surface, wherein each blade defines a blade chord length between the blade leading edge and the blade trailing edge at a radial span disposed at the outer radial surface of the annulus filler adjacent to the suction surface, and wherein a minimum axial distance between the blade leading edge and each of the protruding surface portion and the recessed surface portion is greater than or equal to 30% of the blade chord length.

30. The rotor assembly of claim 29, wherein a maximum axial distance between the blade leading edge and each of the protruding surface portion and the recessed surface portion is less than or equal to 75% of the blade chord length.

31. The rotor assembly of claim 29, wherein the first longitudinal edge is disposed adjacent to the suction surface of one adjacent blade from the plurality of blades and the second longitudinal edge is disposed adjacent to the pressure surface of another adjacent blade from the plurality of blades.

32. A gas turbine engine including at least one annulus filler of claim 17.
